(19) United States
(12) Patent Application Publication
(10) Pub. No.: US 2025/0146344 A1
(43) Pub. Date: May 8, 2025

(54) ADJUSTABLE FLOOR MOUNTED PIVOT PLATE

(71) Applicant: Overhead Door Corporation, Lewisville, TX (US)

(72) Inventor: Frank Isioma Edokpayi, Corpus Christi, TX (US)

(21) Appl. No.: 18/680,939

(22) Filed: May 31, 2024

Related U.S. Application Data
(60) Provisional application No. 63/597,234, filed on Nov. 8, 2023.

(51) Int. Cl. E05D 15/06; E05D 15/48

(52) U.S. Cl. CPC E05D 15/0604; E05D 2015/485

(57) ABSTRACT

A telescoping door system is disclosed which includes an adjustable floor mounted pivot plate that is configured to add stability to the door panels of the telescoping door system during a breakout procedure. In particular, the adjustable pivot plate may include a first adjustable tab with a first pivot, a second adjustable tab with a second pivot, and a third pivot. First and second capture devices are also provided which are mounted in inner and outer Swing Slide (SX) door panels, respectively. The first and second capture devices are configured to interface with the first and second pivots, respectively while a Swing Only (SO) door panel is configured to be mounted on the third pivot. During a breakout procedure, the pivot plate reduces lateral motion of the door panels.

### PRIORITY

This application claims the benefit of the filing date of U.S. Provisional Application No. 63/597,234, filed Nov. 8, 2023, which is incorporated herein by reference in its entirety.

This application is related to copending applications “Adjustable Breakout Device” (Atty Docket 58253.270US01), having the same filing date as this application and “Breakout Crawl Arrester” (Atty Docket 58253.274US01) having the same filing date as this application, which are both incorporated by reference herein in their entirety.

### TECHNICAL FIELD

The present disclosure relates generally to sliding door systems, and more particularly to sliding door systems with breakout functionality. In particular, the sliding door system may include an adjustable floor mounted pivot plate that lends support to the panels of the door during a breakout procedure.

### BACKGROUND

Sliding door systems are sometimes used as entryways and exits to intensive care units (“ICU”) and critical care units in hospitals. In particular, patient rooms in these units are often equipped with large manual sliding doors. The doors are often glass (sometimes in aluminum door frames) to allow medical professionals a view of the patients that need round-the-clock monitoring. Because stretchers, wheelchairs, and other medical equipment are frequently moved in and out of the ICU, sliding doors are often employed. ICUs and other hospital facilities also have certain environmental standards that should be maintained to ensure a healthy environment for patient recovery which impact the type of doors available for use. For example, in certain ICUs, the sliding doors do not have tracks to reduce the ingress of contaminants. For example, many intensive care units have sliding doors that are supported without a bottom track that is fixed to the floor. In these types of doors, the upper track provides the primary support and guides the linear motion of the door as it slides to open and close. However, this design can involve putting a large amount of weight on only a few small components of the door, which may lead to wear and damage over time, as well as decreased functionality of the doors.

Another requirement of some sliding doors such as those used in a hospital application is the ability to “breakout.” That is, these doors should have the ability to rotate off the track, so that a pushing force will cause the door to swing open. The terms “breakout,” “breakaway,” and “swingout” refer to the ability of the door to be opened by rotating the panels of the door off of the track, as opposed to the normal sliding motion of the panels. The breakout feature may be employed in various circumstances such as for an emergency or to accommodate larger equipment such as gurneys or patient beds, and should be able to be accomplished without requiring detailed knowledge of the workings of the door or specific steps that must be followed to allow emergency egress through a telescoping sliding door that has been broken away.

However, many existing breakout doors are problematic because they lack sufficient support for the weight required for the breakout door panels. For example, breakout doors are generally only supported by one or two support points. The components bearing this weight may wear out over time and cause damage to the door system and floor beneath.

Another limiting aspect to many breakout capable sliding doors is that the bottom pivots for these systems are generally fixed and only offer support in one axis. If the pivot cutouts at the bottom of the slide panels are not perfectly aligned to the floor mounted pivot, attempting to open the door in a breakout procedure can damage various components including the pivot, track, and panels. Further, if the breakout system for these sliding doors is not sufficiently strong to hold up the weight of the door panels (which is often the case), the pivot offers no support at the initial stage of the breakout procedure, which may cause the non-pivot end of the door panels to drop and drag on the ground. Therefore, needs exist for a more robust and adjustable pivot system for telescoping doors with breakout functionality.

### SUMMARY

One or more of the foregoing needs may be met by embodiments in accordance with the present disclosure, wherein, some embodiments may include a telescoping door system, which may include: an adjustable pivot plate including: a base plate; a first adjustable tab mounted on the base plate; a first pivot disposed on the first adjustable tab; a second adjustable tab mounted on the base plate; and a second pivot disposed on the second adjustable tab; a Swing Only (SO) door panel; an inner Swing Slide (SX) door panel configured to slide in a lateral direction with respect to the SO door panel, the inner SX door panel comprising a first capture device configured to interface with the first pivot; and an outer SX door panel configured to slide in a lateral direction with respect to the SO door panel and the inner SX door panel, the outer SX door panel comprising a second capture device configured to interface with the second pivot, wherein the inner SX door panel and the outer SX door panel are configured to rotate about the first and second pivots, respectively during a breakout procedure.

In some implementations, the first adjustable tab comprises a first slot and the second adjustable tab comprises a second slot. The first adjustable tab may be attached to the pivot plate with a first set screw such that the first adjustable tab is adjustable in a lateral direction, while the second adjustable tab may be attached to the pivot plate with a second set screw such that the second adjustable tab is adjustable in the lateral direction. The first pivot may have a circular cross-sectional shape while the second pivot may have an oblong cross-sectional shape. The first capture device may be configured to prevent excessive lateral movement between the first capture device and the first pivot during a breakout procedure. The second capture device may be configured to prevent excessive lateral movement between the second capture device and the second pivot during a breakout procedure.

In some implementations, the second capture device is configured to contact outer walls of the second pivot during a breakout procedure. The adjustable pivot plate may include a third pivot, wherein the SO door panel is configured to be mounted on the third pivot such that the SO door panel is rotatable around the third pivot during the breakout procedure. The third pivot may be mounted within a bottom rail of the SO door panel. The first capture device may be mounted within a bottom rail of the inner SX door panel, wherein the second capture device may be mounted within a bottom rail of the outer SX door panel.

An adjustable pivot plate for a telescoping door system is also provided, which may include: a base plate comprising a flat plate with a plurality of drilled holes; a first slotted tab mounted on the base plate in a central region, the first slotted tab configured to be linearly adjustable in a first direction; a first pivot disposed on a distal end of the first slotted tab; a second slotted tab mounted on the base plate in a first end region, the second slotted tab configured to be linearly adjustable in the first direction; a second pivot disposed on a distal end of the second slotted tab; and a third pivot mounted on the base plate in a second end region.

In some implementations, the adjustable pivot plate includes: a first capture device configured to interface with the first pivot; and a second capture device configured to interface with the second pivot. The first capture device may be configured to be mounted within an inner Swing Slide (SX) door panel, wherein the second capture device may be configured to be mounted within an outer SX door panel. The inner SX door panel and the outer SX door panel may be configured to rotate about the first and second pivots, respectively during a breakout procedure of the telescoping door system. The third pivot may be configured to be mounted to a Swing Only (SO) door panel. The SO door panel may be configured to rotate about the third pivot during a breakout procedure of the telescoping door system. A first set screw may also be included that is configured to pass through the first slot to mount the first slotted tab on the base plate. A second set screw may also be included that is configured to pass through the second slot to mount the second slotted tab on the base plate.

A method for using an adjustable pivot plate with a telescoping door system is also provided, which may include: providing a Swing Only (SO) door panel, an inner Swing Slide (SX) door panel, and an outer SX door panel; providing an adjustable pivot plate comprising a base plate, a first slotted tab with a first pivot mounted on the base plate, a second slotted tab with a second pivot mounted on the base plate, and a third pivot mounted on the base plate; mounting a first capture device in the inner SX door panel and a second capture device in the outer SX door panel; attaching the SO door panel to the third pivot; placing the inner SX door panel and outer SX door panel in an open configuration such that the first capture device interfaces with the first pivot and the second capture device interfaces with the second pivot; and rotating the inner SX door panel, the outer SX door panel, and the SO door panel about the first, second, and third pivots, respectively in a breakout procedure.

In some implementations, the first pivot has a circular cross-sectional shape, while the second pivot has an oblong cross-sectional shape. The first capture device may be configured to prevent excessive lateral movement between the first capture device and the first pivot during the breakout procedure, while the second capture device may be configured to prevent excessive lateral movement between the second capture device and the second pivot during the breakout procedure and to prevent movement along the plane of the door.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a perspective view of a telescoping door system according to an embodiment of the present disclosure.

FIG. 2 is an illustration of a top view of the telescoping door system shown in FIG. 1 in a standard (or non-breakout) position according to an embodiment of the present disclosure.

FIG. 3 is an illustration of a top view of the telescoping door system shown in FIG. 1 shown in a breakout position according to an embodiment of the present disclosure.

FIG. 4 is a perspective view of a door frame for a door system where the doors are in a non-broken out position according to an embodiment of the present disclosure.

FIG. 5 is a perspective view of a door frame for a door system where the doors are in a broken out position according to an embodiment of the present disclosure.

FIG. 6 is a perspective view of an adjustable floor mounted pivot plate according to an embodiment of the present disclosure.

FIG. 7 is an exploded view of an adjustable floor mounted pivot plate according to an embodiment of the present disclosure.

FIG. 8A is a perspective view of a capture device according to an embodiment of the present disclosure.

FIG. 8B depicts a first position of the capture device according to an embodiment of the present disclosure.

FIG. 8C depicts a second position of the capture device according to an embodiment of the present disclosure.

FIG. 9A is a perspective view of a capture device according to an embodiment of the present disclosure.

FIG. 9A is a perspective view of a capture device according to an embodiment of the present disclosure.

FIG. 10A is a perspective view of a telescoping door assembly showing the adjustable pivot plate, according to an embodiment of the present disclosure.

FIG. 10B is an enlarged view of a portion of FIG. 38, enlarging the portion encircled by circle H in FIG. 38, according to an embodiment of the present disclosure.

FIG. 11 is a flowchart illustrating a method for using a telescoping door system with an adjustable breakout device according to embodiments of the present disclosure.

### DETAILED DESCRIPTION

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

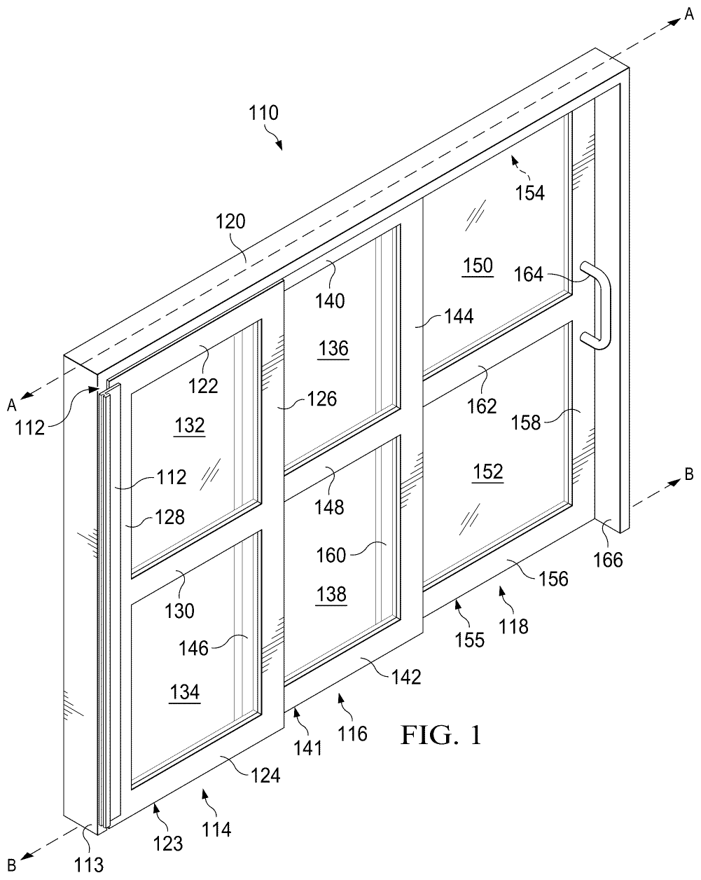

FIG. 1 is a perspective view of a sliding door system (such as a telescoping door system) 110 which may include door panels 114, 116, 118 (which may also be referred to as doors). In particular, the telescoping door system 110 may include a sidelite panel 114, a slow slide panel 116, and a fast slide panel 118. The panels or door panels 116, 118 are slidable and all panels 114, 116, and 118 are able to pivot (i.e., suitable for breakout). When the panels 116 and 118 are slid to the closed position, this may be referred to as the slide closed position as shown in FIG. 1. The sidelite panel 114 is coupled to the trailing door jamb 113 for pivotal movement, however, the sidelite panel 114 does not move linearly. The slide panels 116, 118 are also known as the Swing Slide or “SX,” panels or doors and the sidelite panel 114 is known as the Swing Only or “SO” panel or door.

The teachings of the present disclosure are not limited to a three-panel telescoping door system, but rather may be also employed with a dual-panel slide/swing door system. In this case, the telescoping door system 110 would include a single sliding door panel (such as 116) as well as a nonsliding door panel (such as 114). In other implementations, two, three, or more than three door panels may be included in the telescoping door system 110.

In some implementations, the door panels 114, 116, 118 are arranged to extend in approximately the same direction such that the door panels 114, 116, 118 may be configured to fully or partially close a doorway. In particular, the sidelite panel 114 may be configured to stay relatively motionless during opening or closing of the door system 110, whereas slide panels 116, 118 are configured to move relative to the first door panel 114. The slow slide panel 116 is immediately coupled to the sidelite panel 114, and the fast slide panel 118 is immediately coupled to and leads the slow slide panel 116. The slide panels 116, 118 and the sidelite panel 114 may be supported by a header 120. The header 120 may include a track that guides the linear motion of the slide panels 116, 118 of the telescoping door system 110 (i.e., along path A as shown in FIG. 1). According to certain embodiments, the header 120 may be aluminum or nylon covered aluminum. The slide panels 116, 118 move linearly with respect to the sidelite panel 114 in a telescoping manner with the fast slide panel 118 leading and controlling the linear movement of the slow slide panel 116. This linear movement may also be referred to as sliding movement. The bottom of the slow slide panel 116 may also be guided by a track that is generally located on the underside of the sidelite panel 114 (i.e., running along path B as shown in FIG. 1). The bottom of the fast slide panel 118 is guided by a track formed in a bottom rail 142 of the slow slide panel 116.

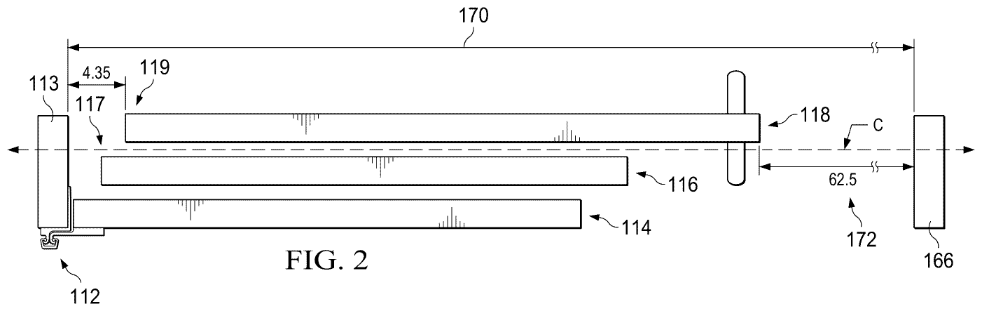

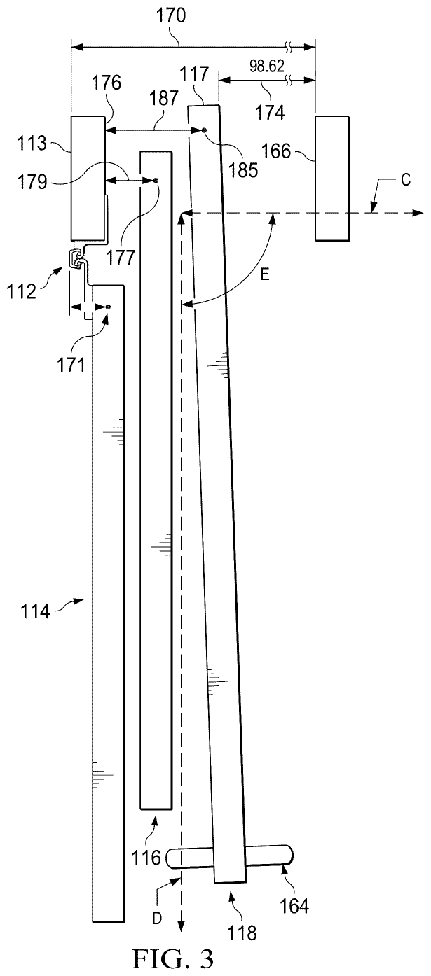

With reference to FIGS. 1-5, the telescoping door system 110 may also include a breakout hinge 112 that allows the panels 114, 116, 118 of the door system 110 to be broken out. When broken out, the panels 114, 116, 118 are able to rotate about the breakout hinge 112 along path E (shown in FIGS. 3 and 5). Breaking out the panels 114, 116, 118 may create a large opening through which oversized equipment, furniture, and the like may fit through. While a specific type of hinge 112 (swing clear continuous geared hinge) is shown in FIG. 2 and FIG. 3, any typical hinge 112 (piano, pin, or any other suitable hinge) may be used as appreciated by one of ordinary skill in the art after reviewing this disclosure.

FIG. 2 is a schematic of a top, plan view of the telescoping door system 110 illustrating the distances of the various panels 114, 116, 118 with respect to the door jambs 113, 166 to illustrate the fully open position (sometimes referred to as the slide open position) of the telescoping door system 110. The area between the lead jamb 166 and the trailing jamb 113 is referred to as the clear opening 170. According to one embodiment, the distance of the clear opening 170 may be 100-120 inches, for example 108 inches. In other embodiments, the clear opening 170 is smaller than 100 inches or greater than 120 inches. Each of the door panels 114, 116, 118 is disposed in the clear opening 170, and a portion of the clear opening 170 defines the slide opening 172 and the breakout opening 174 (also referred to as a pivot opening or a swing opening) (see FIG. 3). The slide opening 172 is present and at its greatest length when the slide panels 116, 118 are fully slid open linearly. That is, the slow slide panel 116 and the fast slide panel 118 are each positioned linearly closest to the trailing jamb 113. The panels 114, 116, 118 of the telescoping door system 110 may be configured to slide along line C as shown in FIG. 2.

FIG. 3 illustrates a schematic of a top, plan view of the telescoping door system 110 which has been broken out. In particular, the panels 114, 116, 118 have been pivoted such from their original arrangement along line C to a breakout line D (where angle E is the angle between lines C and D). This breakout position forms breakout opening 174. The pivot motion of the sidelite panel 114 is facilitated by the hinge 112. The breakout opening 174 illustrated in FIG. 3 is created when each of the slide panels 116, 118 are positioned closest to the trailing jamb 113 and each of the slide panels 116, 118 and the sidelite panel 114 are pivoted such the panels 114, 116, 118 are rotated approximately 90 degrees toward the sidelite side of the clear opening 170. In other implementations, the panels 114, 116, 118 may be rotated less than 90 degrees in a breakout position.

In this breakout position, the panels 114, 116, 118 cannot be linearly moved with respect to each other to close the slide opening 172. The breakout opening 174 is significantly larger than the slide opening 172. In a hospital, the slide opening 172 is used for ingress and egress of typical foot traffic, but if a bed or other large equipment needs to be moved through the door system 110, the panels 114, 116, 118 may be pivoted to create the larger breakout opening 174.

In some implementations, tracks 123, 141, 155 may be disposed in the underside of each of the door panels 114, 116, 118, respectively. These tracks may be used to constrain and guide the motion of door panels 116, 118 with respect to the other slide panels 114, 116, 118. A pivot assembly may also be included that is disposed within these tracks 123, 141, 155. This pivot assembly is discussed in further detail in the copending application entitled “Adjustable Breakout Device” which is incorporated by reference herein in its entirety.

The sidelite panel 114 may include a top rail 122, a bottom rail 124, a lead rail 126, a trailing rail 128, and a mid-rail 130. An upper pane of glass 132 is framed by a portion of the lead rail 126, the trailing rail 128, the top rail 122, and the mid-rail 130. A lower pane of glass 134 is framed by portions of the lead rail 126, the trailing rail 128, the bottom rail 124, and the mid-rail 130. The slow slide panel 116 similarly includes upper and lower glass panes 136, 138 framed by a top rail 140, a bottom rail 142, a lead rail 144, a trailing rail 146, and a mid-rail 148. The fast slide panel 118 also includes upper glass pane 150 and lower glass pane 152 framed by an upper rail 154, a bottom rail 156, a lead rail 158, a trailing rail 160, and a mid-rail 162. The rails may be made of any suitable material such as steel, other metals, PVC, wood, composites, or the like. However, in certain embodiments a lightweight material, such as aluminum may be used for the various rails of the door system 110. According to an alternate embodiment, each panel may have no glass panes, one glass pane, two glass panes, or more than two glass panes.

A user may move the telescoping door system 110 from a fully open position to a fully closed position by manually applying a force to a handle 164 disposed on the lead rail 158 of the fast slide panel 118 to displace the fast slide panel 118 toward a lead jamb 166. The fast slide panel 118 is linearly displaced a certain distance, and it catches the slow slide panel 116 and displaces it toward the lead jamb 166 until the fast slide panel 118 reaches the lead jamb 166. The fast slide panel 118 may be positively latched to maintain the door system 110 in the fully closed position. To move the telescoping door system 110 from the fully closed position to the fully open position, the reverse occurs when the user applies the force to the fast slide panel 118 to linearly displace it toward the trailing jamb 113 (also referred to herein as a pivot jamb), and after the fast slide panel 118 is linearly displaced a certain distance, it catches the trailing end 117 (see FIG. 2) of the slow slide panel 116 and displaces it toward the trailing jamb 113. Alternatively, the linear motion of the slide panels 116, 118 may be driven by an operator for automatic sliding movement of the panels 116, 118.

In pivoting the panels 114, 116, 118 to form the breakout opening 174, each panel 114, 116, 118 may pivot on its own pivot axis 171, 177, 185, respectively. Each pivot axis 171, 177, 185 location and door system 110 dimensions are selected to allow the other adjacent panels to pivot approximately 90 degrees without the panels 114, 116, 118 interfering with each other.

It should be understood that the slide open limit of the slow slide panel 116 is associated with its pivot axis 177. So, when the slow slide panel 116 is slid open such that its trailing end 117 is positioned closest to the trailing jamb 113, (as shown in FIG. 2) the slow slide panel 116 is in position to allow it to pivot to its breakout position without interfering with the pivot motion of the sidelite panel 114. The same is true for the fast slide panel 118.

As shown in FIG. 3, the pivot axis 177 of the slow slide panel 116 is disposed a distance 179 from the face 176 of the trailing jamb 113 and the pivot motion of the slow slide panel 116 does not interfere with the pivot motion of the sidelite panel 114. Similarly, the pivot axis 177 of the slow slide panel 116 is disposed a closer distance 179 to the face 176 of the trailing jamb 113 than the distance 187 of the pivot axis 185 and the pivot motion of the fast slide panel 118 and does not interfere with the pivot motion of the slow slide panel 116.

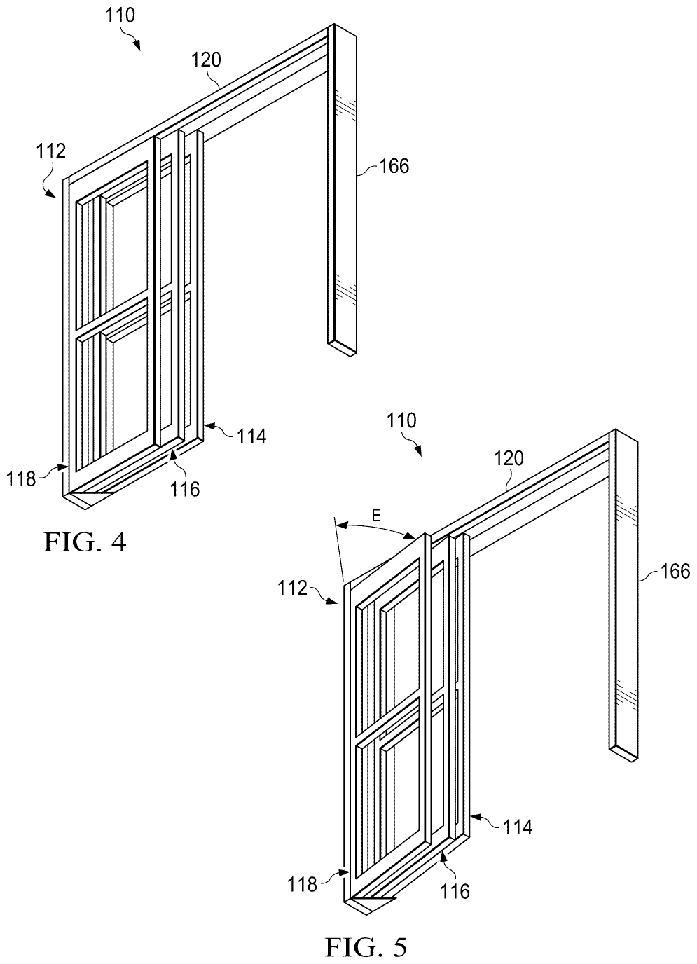

FIGS. 4 and 5 show a perspective view shown from the bottom from an angle of the door system 110. FIG. 4 shows the door system 110 in a non-broken out or pivot closed position, and FIG. 5 shows the door system 110 is a partially broken out or pivot open position. The door system 110 includes the sidelite panel 114, the slow slide panel 116, and the fast slide panel 118. The header 120 and lead jamb 166 are also shown.

The telescoping door system 110 may also be one half of a dual telescoping door system 110 where a second multi-panel telescoping door is disposed opposite the telescoping door system 110 such that a fully closed position has the two telescoping door systems 110 meeting each other in a center of the door frame or opening.

In some implementations, the telescoping door system 110 may include a floor mounted track passing along path B that may help to guide the linear or sliding motion of the slide panels 116, 118. In other implementations, the telescoping door system may not include a floor mounted track. For example, in certain healthcare facilities such as an intensive care unit in a hospital, it may be undesirable to have a floor track.

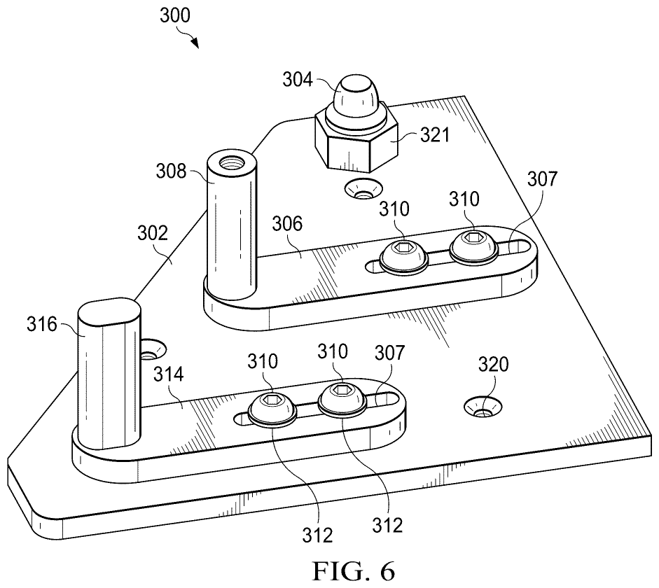

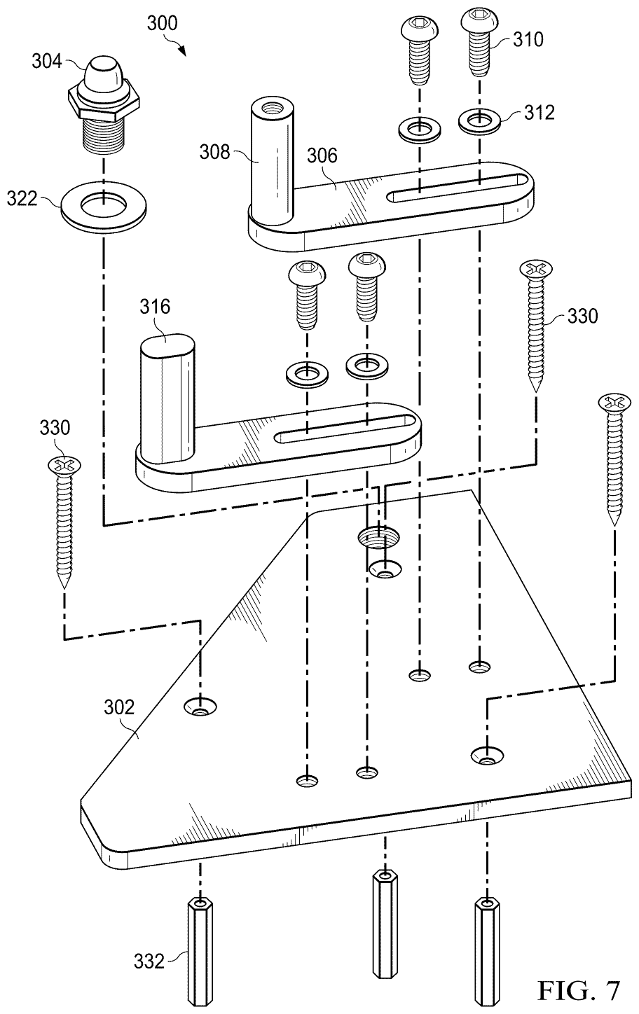

In various implementations, the telescoping door system 110 may include one or more features that improve its functionality over existing designs, and in particular, allow the weight distribution of the door to be adjusted, ultimately improving the function of the door. These features include an adjustable pivot plate 300 discussed in reference to FIGS. 6-10. These features may also be included in a telescoping door system 110 that is configured for use in various applications. For example, in one implementation, a telescoping door system 110 may be used in a trackless configuration in a hospital that includes an adjustable pivot plate 300. The adjustable pivot plate may be used with the adjustable breakout device and breakout crawl arrester discussed in copending applications “Adjustable Breakout Device” and “Breakout Crawl Arrester” which are incorporated by reference herein in their entirety.

The adjustable floor mounted pivot plate 300 may improve the strength and adjustability of the telescoping door system 110, especially during breakout procedures. Trackless doors, and in particular, telescopic door are notoriously problematic for inconsistencies in the various components used. One common problem with existing designs is that the bottom pivots of many telescopic doors are fixed and only offer support in one axis. Since motion may occur in many different directions, this type of fixed pivot may fail in some circumstances. Another problem is that if the pivot cutouts at the bottom of the slide panels are not perfectly aligned to the floor mounted pivot, attempting to perform a breakout procedure may damage the pivot and the track with the pivot cutout on the panel. Further, in cases where the breakout system is not sufficient to hold up the door weight, the pivot offers no support at the initial stage of the breakout process, which may cause the non-pivot end of the door to drop and drag on the ground which can result in further damage to the door and door panels.

The adjustable floor mounted pivot plate 300 provides a solution to these problems by providing two axis support in both the X and Y directions. This may in turn increase the rigidity of the combined door panel system during a breakout procedure which may reduce the amount of stress on various components as well as the amount that the non-pivot end of the door drops. Furthermore, the adjustability of the adjustable pivot plate 300 may accommodate for variations in the production or assembly of telescoping door systems 110. This may reduce costs to rework door panel assemblies, supply costs associated with replacing damaged or defective components, and improve customer experience with the operation of installed units.

In some implementations, the telescoping door system 110 may include an adjustable pivot plate 300 as show in FIG. 6. This pivot plate 300 may be floor mounted, such that door panels 114, 116, 118 of the telescoping door system are mounted on the adjustable pivot plate 300. The pivot plate 300 may be configured as a second two axis (X, Y) pivot point for the telescoping door system 110 during breakout procedures. The adjustability of the pivot plate 300 may accommodate variations to the telescoping door system 110 that occur during manufacture and installation. The pivot plate may include a base plate 302, a bottom pivot 304 for a SO (Swing Only) door panel 114, a slotted tab 306 for an inner SX (Swing Slide) door panel 116, a pivot 308 for the inner SX door panel 116, set screws 310, split washers 312, a slotted tab 314 for an outer SX door panel 118, and a pivot 316 for the outer SX door panel 118.

The pivot plate 300 may include the major components of the base plate 302 and slotted tabs 306, 314 that are attached to the base plate 302 that accommodate the various other elements. In one embodiment, the base plate 302 is made from a ¼ inch thick aluminum plate with three countersunk holes 320 to screw the base plate 302 to the floor. The base plate 302 may also have holes drilled in it to accommodate the other hardware, such as four ¼″-20 threaded through holes, two in-line with each SX door panel 116, 118 and separated by ¾ inch, and one ½″-20 threaded through hole for the bottom pivot component for the SO door panel 114. In other embodiments, other configurations of holes may be used to accommodate different mounting configurations. In some implementations, the bottom pivot 304 may include a nut 321 as shown in FIG. 6 or one or more washers 322 as shown in FIG. 7. This may allow the height of the bottom pivot 304 to be adjusted to accommodate different sizes of SO door panels 114.

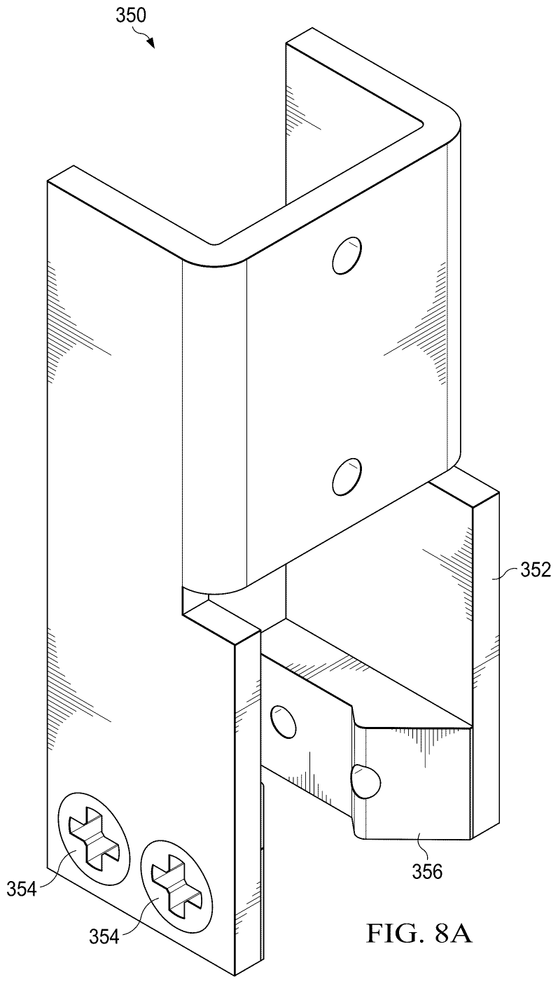

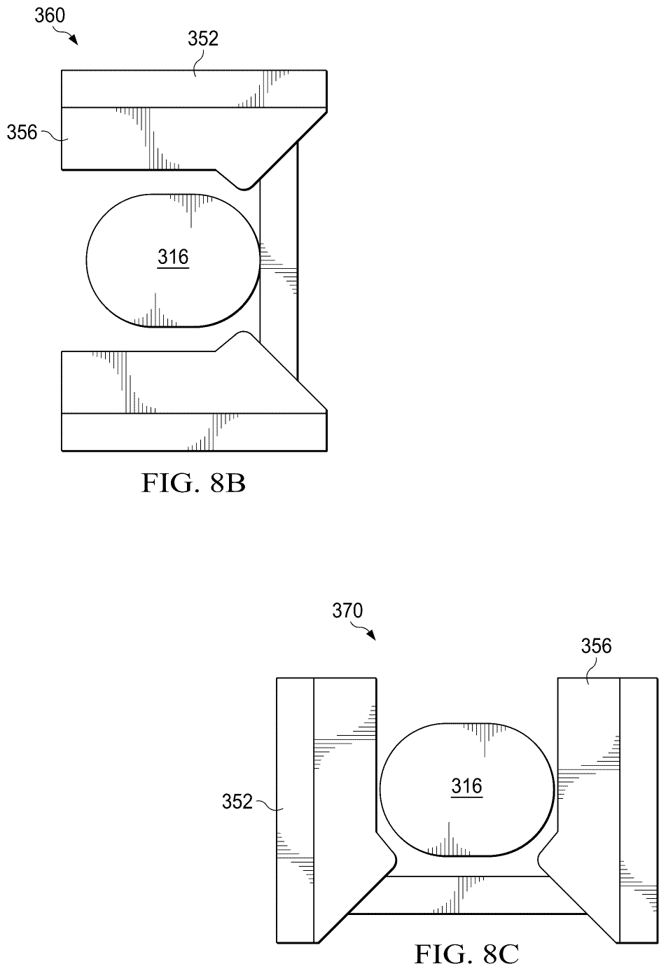

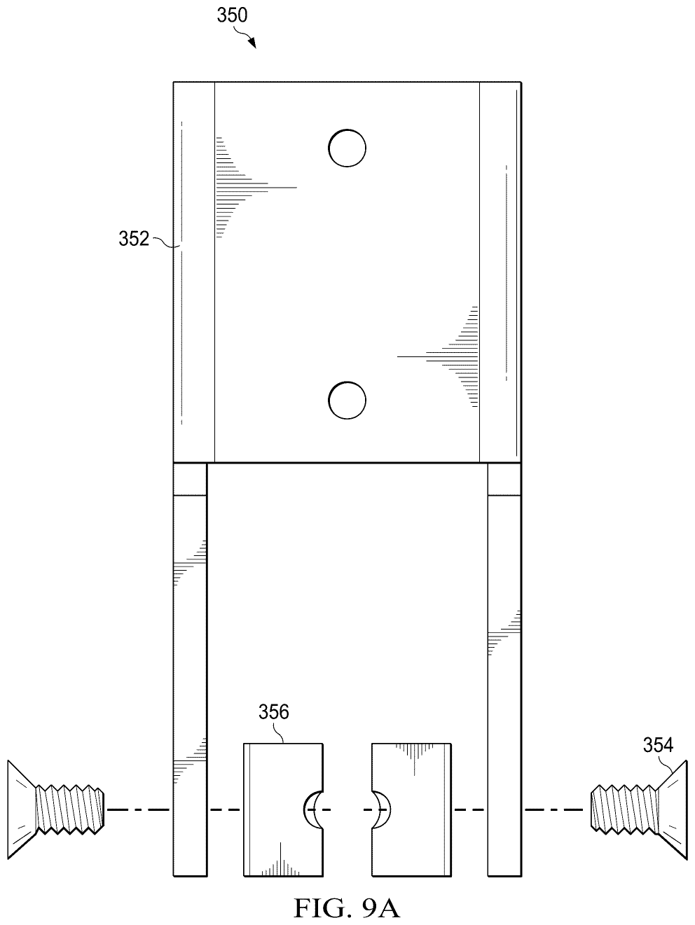

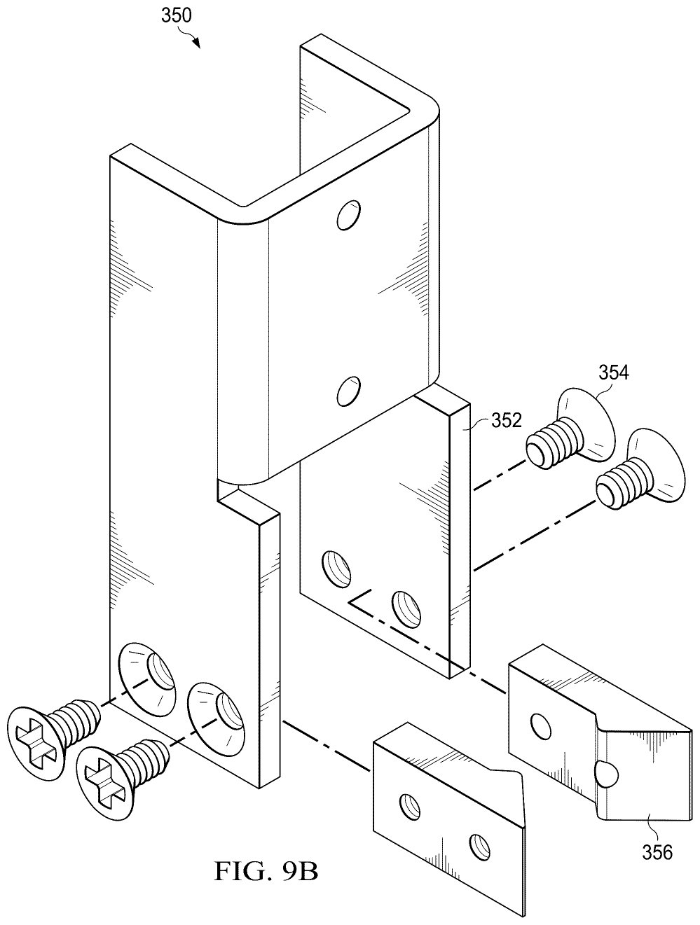

Still referring to FIG. 6, the slotted tabs 306, 314 may have a roughly rectangular shape with rounded ends. In some embodiments, the slotted tabs 306, 314 have the same size and shape. In one embodiment, the slotted tabs 306, 314 are made from ¼ inch thick steel plate. A slotted hole 307 may be formed through the middle of the tabs 306, 314 which may run parallel to the long side of the tabs 306, 314. In one embodiment, the slotted hole 307 is 1.5 inches between centers and has a radius of 0.131 inch. Pivots 308, 316 may be mounted on each tab 306, 314 such that they are rigidly fixed. The pivot 308 for the inner SX door panel 116 may have a cylindrical shape while the pivot 316 for the outer SX door panel 118 may have an oblong cross-section. The purpose of this geometry may function during a breakout procedure, such that as the panel rotates around it, the oblong pivot 316 for the outer SX door panel 118 is captured by a capture device 350 mounted at the bottom of the door panel 118 (shown in FIGS. 8A-9B), such that the panel 118 cannot be pulled or knocked away from the pivot 316 for the outer SX door panel 118 at the bottom when the door panel 118 is broken out. The slotted tabs 306, 314 with the pivots 308, 316 attached to them may be mounted to the base plate 302 via set screws 310 and split washers 312. In one embodiment, the set screws 310 are ¼″-20 button head socket cap screws (BHSCS), and two of these set screws 310 may be used for each slotted tab 306, 314. In other embodiments, other sizes and configurations of set screws 310 may be used. The set screws 310 may allow for movement of the slotted tabs 306, 314 relative to the base plate 302 when the set screws 310 are loosened. In one embodiment, loosening the set screws 310 may allow for a maximum travel of ¾ inch from end to end.

FIG. 7 shows an exploded view of the adjustable pivot plate 300. In some implementations, the adjustable pivot plate 300 is mounted on the floor via screws 330 passing through the base plate 302 and into anchors 332 that may be disposed within the floor.

FIG. 8A shows a perspective view of a capture device 350 that may be used in conjunction with the pivot 316 for the outer SX door panel 118. In particular, the capture device 350 may have side walls 352 as well as inner members 356. The inner members 356 may be connected to the side walls 352 via screws 354. The inner members 356 may include sloped inner surfaces that are configured to catch the oblong outer surface of the pivot 316 as it is rotated, thereby stopping the rotation of the door panel 116, 118 to which the capture device 350 is attached, as shown in FIGS. 8A and 8B. In various implementations, the capture device 350 may be mounted on any of the sliding door panels 116, 118. In particular, the capture device 350 will freely allow motion of the pivot 316 and therefore slide motion in the position shown in FIG. 8B. However, when the door panels 114, 116, 118 are broken out as shown in the position of FIG. 8C, the capture device 350 renders the pivot 316 immobile therefore preventing the bottom of the sliding door panel 116, 118 from being knocked out if impacted by an external force. Further perspective views of the capture device 350 are shown in FIGS. 9A and 9B.

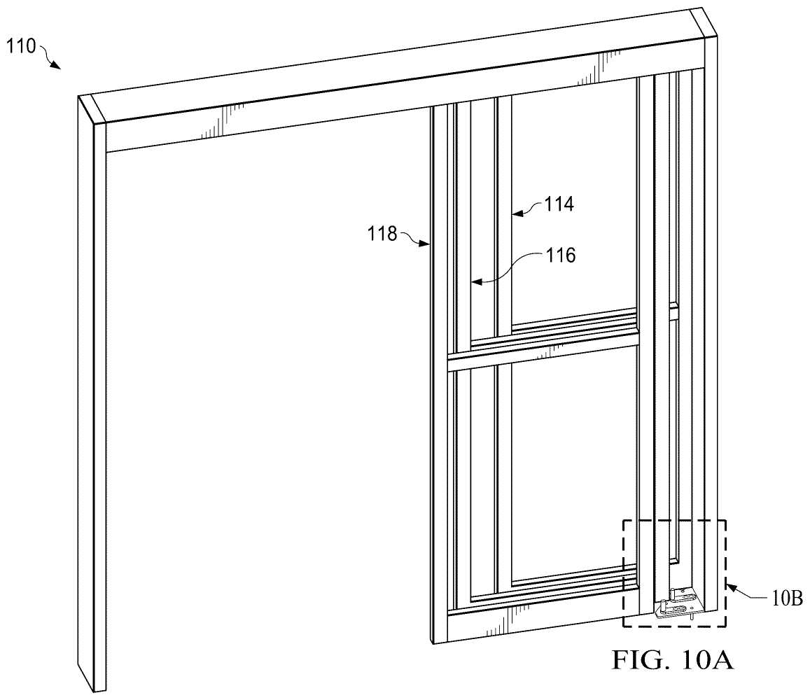

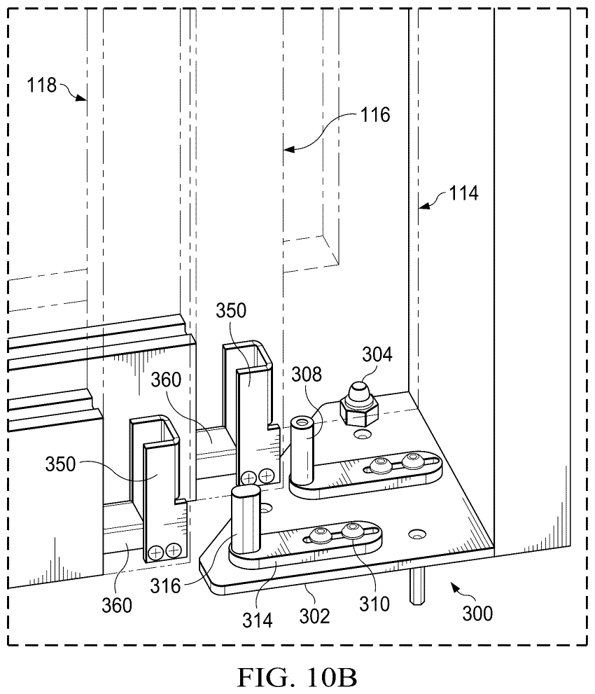

The position of the capture device 350 inside the various door panels 116, 118 of the telescoping door assembly 110 is shown in FIGS. 10A and 10B. FIG. 10B also shows guide extrusions 360 which act as a stop in front of the capture devices 350 inside of the door panels 116, 118. The guide extrusions 360 bear on the pivots 308, 316 when the door panels 116, 118 are broken out.

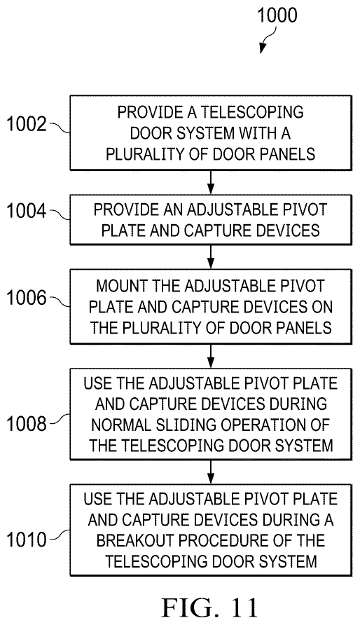

FIG. 11 shows a flowchart illustrating a method 1000 for using a sliding door system (such as a telescoping door system) with an adjustable pivot plate and capture device according to embodiments of the present disclosure.

The method 1000 may include block 1602 to provide a telescoping door system with a plurality of door panels such as telescoping door system 110 including panels 114, 116, 118 as discussed in reference to FIGS. 1-10B. In some implementations, this telescoping door system may be configured to breakout such that the door panels may be pivoted from the normal sliding configuration to a breakout configuration. This may provide additional clearance in the doorway of the telescoping door system.

The method 1000 may also include block 1004 to provide an adjustable pivot plate and capture devices on the plurality of door panels. This adjustable pivot plate and capture device may be the adjustable pivot plate 300 and capture device 350 discussed in reference to FIGS. 6-10B, respectively. The adjustable pivot plate may include a base plate as well as multiple two axis (X, Y) adjustable pivot points for door panels during a breakout procedure. Capture devices may be mounted on each of the sliding door panels (i.e., door panels 116 and 118 as shown in FIGS. 10A and 10B).

The method 1000 may also include block 1006 to mount the adjustable pivot plate and capture devices on the plurality of door panels of the telescoping door system. In some implementations, the adjustable pivot plate is configured to provide adjustable pivots for two or more sliding door panels as well as a stationary pivot point for the non-sliding door panel (as shown in FIGS. 10A and 10B). Capture devices may be mounted on each of the sliding door panels, corresponding to the adjustable pivots of the adjustable pivot plate. The pivots of the pivot plate may be adjusted to precisely fit the location of the capture devices when the door is in the “open” position (i.e., all of the door panels are close together).

The method 1000 may also include block 1008 to use the adjustable pivot plate and capture devices during normal sliding operation of the telescoping door system. In particular, sliding door panels may be moved linearly away from the pivot plate and pivot points. In this configuration, the capture devices move allow free movement of the pivots and do not impede lateral motion of the door panels.

The method 1000 may also include block 1010 to use the adjustable pivot plate and capture devices during a breakout procedure of the telescoping door system. In this case, the door panels are all positioned close together (i.e., in the configuration show in FIGS. 10A and 10B). The pivots are closely held in the capture devices, which impedes lateral motion of the door panels while allowing rotational motion about the pivots. This may provide stable pivoting of all the respective door panels as they swing open during the breakout procedure while reducing unwanted motion of the door panels. Blocks 1008 and 1010 may also include adjusting the various pivot points as needed during use of the telescoping door system. For example, the position of the pivots may be updated overtime to provide more stability to the door panels as components wear over time. The use of method 1000 may reduce damage to components of the telescoping door system, especially during breakout procedures.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

We claim:

1. A telescoping door system, comprising:
an adjustable pivot plate including:
a base plate;
a first adjustable tab mounted on the base plate;
a first pivot disposed on the first adjustable tab;
a second adjustable tab mounted on the base plate; and
a second pivot disposed on the second adjustable tab;
a Swing Only (SO) door panel;
an inner Swing Slide (SX) door panel configured to slide in a lateral direction with respect to the SO door panel, the inner SX door panel comprising a first capture device configured to interface with the first pivot; and
an outer SX door panel configured to slide in a lateral direction with respect to the SO door panel and the inner SX door panel, the outer SX door panel comprising a second capture device configured to interface with the second pivot, wherein the inner SX door panel and the outer SX door panel are configured to rotate about the first and second pivots, respectively during a breakout procedure.

2. The telescoping door system of claim 1, wherein the first adjustable tab comprises a first slot and the second adjustable tab comprises a second slot.

3. The telescoping door system of claim 2, wherein the first adjustable tab is attached to the pivot plate with a first set screw such that the first adjustable tab is adjustable in a lateral direction, wherein the second adjustable tab is attached to the pivot plate with a second set screw such that the second adjustable tab is adjustable in the lateral direction.

4. The telescoping door system of claim 1, wherein the first pivot has a circular cross-sectional shape, wherein the second pivot has an oblong cross-sectional shape.

5. The telescoping door system of claim 4, wherein the first capture device is configured to prevent excessive lateral movement between the first capture device and the first pivot during a breakout procedure.

6. The telescoping door system of claim 4, wherein the second capture device is configured to prevent excessive lateral movement between the second capture device and the second pivot during a breakout procedure.

7. The telescoping door system of claim 4, wherein the second capture device is configured to contact outer walls of the second pivot during a breakout procedure.

8. The telescoping door system of claim 1, wherein the adjustable pivot plate comprises a third pivot, wherein the SO door panel is configured to be mounted on the third pivot such that the SO door panel is rotatable around the third pivot during the breakout procedure.

9. The telescoping door system of claim 8, wherein the third pivot is mounted within a bottom rail of the SO door panel.

10. The telescoping door system of claim 1, wherein the first capture device is mounted within a bottom rail of the inner SX door panel, wherein the second capture device is mounted within a bottom rail of the outer SX door panel.

11. An adjustable pivot plate for a telescoping door system, comprising:
a base plate comprising a flat plate with a plurality of drilled holes;
a first slotted tab mounted on the base plate in a central region, the first slotted tab configured to be linearly adjustable in a first direction;
a first pivot disposed on a distal end of the first slotted tab;
a second slotted tab mounted on the base plate in a first end region, the second slotted tab configured to be linearly adjustable in the first direction;
a second pivot disposed on a distal end of the second slotted tab; and
a third pivot mounted on the base plate in a second end region.

12. The adjustable pivot plate of claim 11, further comprising:
a first capture device configured to interface with the first pivot; and
a second capture device configured to interface with the second pivot.

13. The adjustable pivot plate of claim 12, wherein the first capture device is configured to be mounted within an inner Swing Slide (SX) door panel, wherein the second capture device is configured to be mounted within an outer SX door panel.

14. The adjustable pivot plate of claim 13, wherein the inner SX door panel and the outer SX door panel are configured to rotate about the first and second pivots, respectively during a breakout procedure of the telescoping door system.

15. The adjustable pivot plate of claim 11, wherein the third pivot is configured to be mounted to a Swing Only (SO) door panel.

16. The adjustable pivot plate of claim 15, wherein the SO door panel is configured to rotate about the third pivot during a breakout procedure of the telescoping door system.

17. The adjustable pivot plate of claim 11, further comprising:
a first set screw that is configured to pass through the first slot to mount the first slotted tab on the base plate; and
a second set screw that is configured to pass through the second slot to mount the second slotted tab on the base plate.

18. A method for using an adjustable pivot plate with a telescoping door system, comprising:
providing a Swing Only (SO) door panel, an inner Swing Slide (SX) door panel, and an outer SX door panel;
providing an adjustable pivot plate comprising a base plate, a first slotted tab with a first pivot mounted on the base plate, a second slotted tab with a second pivot mounted on the base plate, and a third pivot mounted on the base plate;
mounting a first capture device in the inner SX door panel and a second capture device in the outer SX door panel;
attaching the SO door panel to the third pivot;
placing the inner SX door panel and outer SX door panel in an open configuration such that the first capture device interfaces with the first pivot and the second capture device interfaces with the second pivot; and
rotating the inner SX door panel, the outer SX door panel, and the SO door panel about the first, second, and third pivots, respectively in a breakout procedure.

19. The method of claim 18, wherein the first pivot has a circular cross-sectional shape, wherein the second pivot has an oblong cross-sectional shape.

20. The method of claim 18, wherein the first capture device is configured to prevent excessive lateral movement between the first capture device and the first pivot during the breakout procedure, wherein the second capture device is configured to prevent excessive lateral movement between the second capture device and the second pivot during the breakout procedure and to prevent movement along the plane of the door.
